(19) United States
(12) Patent Application Publication
(10) Pub. No.: US 2008/0319775 A1
(43) Pub. Date: Dec. 25, 2008

(54) BOWLING SYSTEM

(76) Inventor: Charles Housman, Newton, MA (US)

Correspondence Address: WOLF GREENFIELD & SACKS, P.C., 600 ATLANTIC AVENUE, BOSTON, MA, 02210-2206, US

(21) Appl. No.: 11/767,752

(22) Filed: Jun. 25, 2007

(51) Int. Cl. G06Q 50/00

(52) U.S. Cl. 705/1

(57) ABSTRACT

A system for managing data associated with one or more bowling centers. The system includes a bowling center databases that collects information associated with patrons of an associated bowling center and a central database server that communicates with each of a plurality of bowling center databases. The system may be used to track expenditures made by patrons and issue rewards points to patrons, who may later redeem the rewards points for goods or services from the bowling centers or third parties. The system may be used to administer a loyalty program which tracks expenditures made by patrons and issues rewards points to patrons, who may later redeem the rewards points for goods or services from the bowling centers or third parties, or by bowling center owners for general customer management and marketing with services such as automated electronic mail.

### BACKGROUND

1. Field

Aspects of the invention relate to a system for managing information associated with bowling centers, and more particularly to a wide area network for managing such information.

2. Discussion of Related Art

Information management systems in present day bowling centers are limited, in that the systems are only capable of gathering information from bowlers who patronize the bowling center where the system resides. Systems do not exist which allow bowling center managers to automatically aggregate information from patrons and to share such information across multiple bowling centers.

The applications have appreciated that a need exists to create a system which can automatically gather and share bowling center patron information.

### SUMMARY

According to one aspect of the invention, as system is disclosed for managing data associated with a bowling center. The system comprises a plurality of bowling center databases, where each of the plurality of bowling center databases is associated with one of a plurality of bowling centers and is configured to aggregate information associated with patrons of the associated bowling center. A firewall is associated with each of the plurality of bowling center databases and is configured to prevent unauthorized access to the associated bowling center database. A database server is configured to communicate with each of the plurality of bowling center databases to provide aggregated information of the patrons.

According to one embodiment, the information comprises addresses, phone numbers, purchase amounts, purchase types, dates, and bowling game information of the patrons.

Various embodiments may allow the database server to be accessed remotely by patrons from locations outside of the bowling center, such as from personal computers of a patron.

Communication between the database server and the plurality of bowling center databases may be encrypted communication. Communication between the database server and the plurality of bowling center databases may also occur at regularly scheduled intervals.

Embodiments of the system may include a module for generating electronic mail messages to be sent to one or more recipient patrons. The module may be configured to automatically identify the recipient patrons based on one or more of bowling center membership criteria, such as patron name, patron gender, patron age, or league membership criteria. The module may also be configured to allow an authorized user to edit the electronic mail messages prior to the electronic mail messages being sent to the recipient patrons. The module may configured to personalize electronic mail messages for each of the recipient patrons.

Embodiments of the database server may aggregate reward points for patrons of the plurality of bowling centers based on purchase information sent to the database server.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic view of information flow about a wide area network, according to one embodiment of the invention.

FIG. 2 is a schematic view of information flow about a local area network, according to one embodiment of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving”, and variations thereof herein, is meant to encompass the items listed thereafter and equivalents thereof as well as additional items.

According to aspects of the invention, systems and methods are used to aggregate information associated with patrons of bowling centers. Each of the bowling centers may include a bowling center database that collects information from patrons, such as personal information, bowling information for a patron, and information associated with purchases made by a patron. One or more database servers may communicate with the bowling center databases to synchronize to one another. The database server may also be accessed by patrons, or other authorized users, from outside of a bowling center through client computers, such as a patron's personal computer.

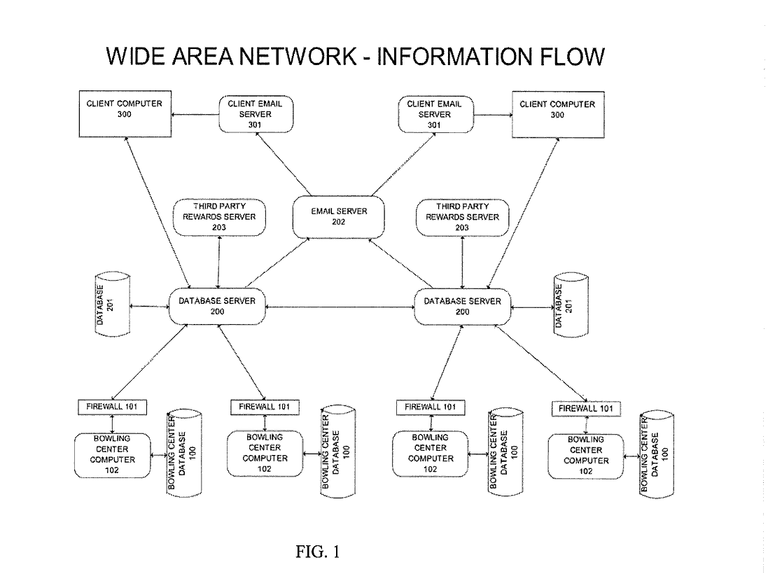

Turn now to the figures, and initially FIG. 1, which shows a schematic view of the flow of information between bowling center databases 100, database servers 200, and client computers 300. As shown, each of a plurality of different bowling centers may include a bowling center database 100 and a bowling center computer 101. The database 100 and computer 101 may act together to acquire and aggregate information associated with patrons of the bowling center.

The database server(s) 200 are typically located off site from the bowling center. The server(s) 200 include a database 201 for storing information associated with patrons of the bowling centers. The database servers may also communicate with a third party rewards server 203 that aggregates information associated with patron purchases and reward points that have been issued or redeemed by patrons. As is also shown in FIG. 1, the database server(s) may be associated with an email server 202 configured to create email messages to be sent to select patrons of the bowling centers, as is discussed herein.

The system may also include various features to safeguard information that exists on either the database servers 200, the bowling center databases 100, or elsewhere in the system. According to some embodiments, as shown in FIG. 1, firewalls 101 may be in place to prevent unauthorized access of the computer 102 and database 100, and to prevent outgoing communication from computer 102 except to database server 200. Additionally or alternatively, communications between the various components of the system may be encrypted, such that information relating to patrons may be protected, even if communications are intercepted.

Various types of information may be collected by the bowling center databases and/or data servers. By way of non-limiting example, the information may include patron names, patron addresses, patron phone numbers, patron email addresses, dollar amount purchases made by each patron, types of purchases made by each patron, and the like, as aspects of the invention are not limited in this respect. Additionally, information that relates to a rewards program may also be collected and maintained on the bowling center database 100 and the database 201 of the database server 200. This information may include the amount of rewards points that a patron has, the amount of rewards points that a patron has spent, and the types of purchases that a patron has made using rewards points, among other things.

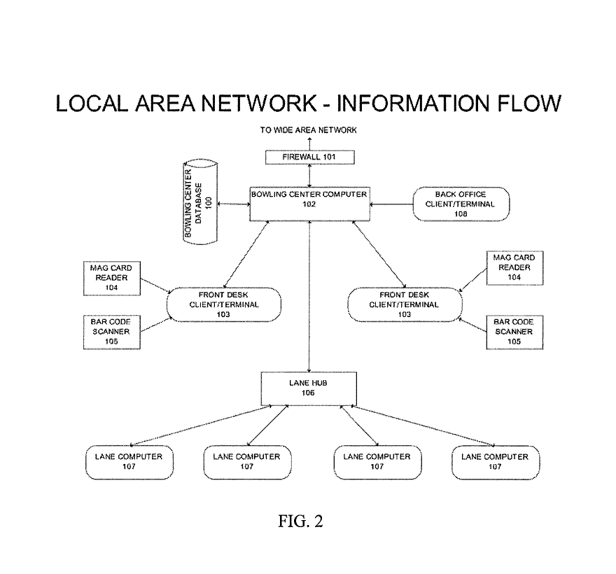

Embodiments of the system may aggregate information locally at bowing centers, or from other locations, such as client computers 300, after which time the information is downloaded to bowling center computers. FIG. 2 shows one example of local information flow to the bowling center computer 102 and database 100 at a bowling center.

As shown in FIG. 2, data may be collected directly from lane computers 107, which directly operate the mechanisms and scoring systems associated with each lane in a bowling center. Types of information typically gathered from lane computers includes patron game and frame pinfall information, although any other type of information may also be acquired from a lane computer. As shown, the lane computers communicate with the bowling center computer 102 through a lane hub 106, where data from the lane computers 107 is first gathered.

Information from a front desk, sales desk, or other terminal 103 in a bowling center may also be gathered by the bowling center computer 102 and bowling center database 103, as illustrated in FIG. 2. This information typically relates to purchases made by a patron, such as beverages and food stuffs, pro shop purchases, equipment rentals, and the like. However, other types of information may also be gathered at such points, like reward point redemptions, as aspects of the invention are not limited in this respect.

The system may also include a terminal from which management of the bowling center may access the bowling center computer 102 and database. As shown in FIG. 2, this may comprise a back office client terminal 108. From such a terminal, bowling center management may review information in the database and/or utilize the data to perform various functions, such as composing electronic mail messages to the patrons.

Wide are networks may be utilized to allow patrons to access their reward accounts in the system from off site locations. As shown in FIG. 1, client computers 300 may be used to accomplish this, according to some embodiments. Off site access may also be accomplished with other mechanisms, such as through instant messaging systems or text messaging systems, as aspects of the invention are not limited in this respect.

Embodiments of the system may include features to synchronize data among the various bowling center databases 100 and database servers 200. According to one embodiment, each bowling center database 100 and database server 200 is associated with software that checks for inconsistencies in the databases. When an inconsistency is identified, updates are made to each of the databases. In this respect, changes initiated at any database may be disseminated to other databases in the system. The software may be configured to check for inconsistencies on a regularly occurring interval, such as every 24 hours, although other intervals are possible, and some embodiments may be configured to synchronize as soon as data is input into a corresponding database.

Embodiments of the system may allow an authorized user, such as a manager of a bowling center to prepare electronic mail messages to be sent to all or a selected group of patrons in the database 201. Such a subset may include patrons of bowling centers other than that of the manager. The patrons who receive the electronic mail messages may be determined by membership in a particular bowling center, by name, by gender, by age, by membership in a league or other organization, or other data present in the database servers 200. Once requested, automatic emails may be sent on a scheduled basis without the need for future user intervention.

Electronic mail messages may be delivered through an email server 202 and received by various client email servers 301 of the patrons. From there, the electronic mail messages may be delivered to patrons through various client computers 300. Alternately or additionally, embodiments of the system may be configured to create letters to be sent via the US Postal Service.

The system may help compose the electronic mail messages. The system may personalize emails for each patron, such as by including the patron's name, birthday, or other personal criteria, and in this regard, may be better received by patrons. According to some embodiments, the electronic mail messages are created from templates, which may be edited by authorized users before being sent to patrons. However, such intervention may not be required by authorized users when email are created, according to some embodiments.

Information that is collected in the bowling center database 100, such as information relating to purchases that have been made, may be shared with the database server via the bowling center computer 102. In this respect, each of the databases may maintain accurate records of an amount of rewards points that each bowler may have in their account. Patrons may query their rewards points totals and history from any remote client computer 300 or directly when they are present at a participating bowling center. Such rewards points may be redeemed at the local bowling center for bowling or other products and services, or may be exchanged for rewards or points with a cooperating third party by communicating with a third party rewards server 203.

Turn again to FIG. 2, which provides a more detailed view of the flow of information through portions of a system that may reside at a bowling center. As shown, data enters and leaves the bowling center database 100 through a bowling center computer 102 and associated firewall 101 to protect the information. A user at the bowling center may enter data, such as name information, address information, purchase information information, bowling information, and the like directly into the bowling center database 100 using a back office client or terminal 108. This data may be entered manually, such as through a keyboard, or automatically, such as by meshing an existing database that includes such information. This information may also be entered automatically with reward program membership card data by reading the card at either a magnetic card reader 104 or bar code scanner 105, such as might be found at a front desk of a bowling center.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for managing data associated with a bowling center, the system comprising:
a plurality of bowling center databases, each of the plurality of bowling center databases associated with one of a plurality of bowling centers and configured to aggregate information associated with patrons of the associated bowling center;
a firewall associated with each of the plurality of bowling center databases, the firewall configured to prevent unauthorized access to the associated bowling center database and unauthorized communication from the bowling center; and
a database server configured to communicate with each of the plurality of bowling center databases;
wherein each of the plurality of bowling center databases is configured to communicate with the database server to provide aggregated information of the patrons.

2. The system according to claim 1, wherein the information comprises addresses, phone numbers, purchase amounts, purchase types, dates, and bowling game information.

3. The system according to claim 1, wherein the database server is configured to be accessed remotely by patrons from locations outside of the bowling center.

4. The system according to claim 1, wherein communication between the database server and the plurality of bowling center databases is encrypted communication.

5. The system according to claim 1, wherein communication between the database server and the plurality of bowling center databases occurs automatically at regularly scheduled intervals.

6. The system according to claim 1, further comprising:
a module for generating electronic mail messages to be sent to one or more recipient patrons.

7. The system according to claim 6, wherein the module is configured to automatically identify the recipient patrons based on one or more of bowling center membership criteria, patron name, patron gender, patron age, league or other membership criteria.

8. The system according to claim 6, wherein the module is configured to allow an authorized user to edit the electronic mail messages prior to the electronic mail messages being sent to the recipient patrons.

9. The system according to claim 6, wherein the module is configured to personalize electronic mail messages for each of the recipient patrons.

10. The system according to claim 6, wherein the database server aggregates reward points for patrons of the plurality of bowling centers.
